(19) United States
(12) Patent Application Publication
(10) Pub. No.: US 2006/0047408 A1
(43) Pub. Date: Mar. 2, 2006

(54) Engine diagnostic apparatus and method that analyzes the output of a driven electric power generator

(76) Inventor: William M. Kayser, Brooklyn Park, MN (US)

Correspondence Address: William M. Kayser, 6408 81st Avenue North, Brooklyn Park, MN, 55445, US

(21) Appl. No.: 10/931,687

(22) Filed: Sep. 1, 2004

(51) Int. Cl. G06F 19/00; F02P 17/00

(52) U.S. Cl. 701/114; 324/379

(57) ABSTRACT

In the present art, the closest detectable points in time that are available for electronic engine analyzers to ascertain of the functionality of most engines are the times when spark pulses occur. The present invention utilizes the output of driven electric power generators to both ascertain when those sparks (or similar signals in engines without sparks) occur, and to ascertain how engines are functioning between those sparks. The invention takes advantage of the fact that during the time between cylinder firings, the output voltage of engine-driven electric power generators is directly related to the instantaneous functionality of the engine. By displaying and analyzing the output of driven electric power generators, the invention's apparatuses and methods are able to show previously unavailable useful information related to the functionality of engines, including the compression inside each cylinder and the power produced by each cylinder.

### FIELD OF THE INVENTION

The invention is in the field of diagnostic analyzers that show combustion-based engine functionality by processing output signals from engine-driven devices.

### BACKGROUND OF THE INVENTION

In the current state of the art, no methods or devices assess the operational performance of engines to diagnose problems or achieve optimum performance based on a display or an analysis of the output signals of electric generators that are coupled to and driven by said engines.

U.S. Pat. No. 4,812,979 titled “Method and Apparatus for Analyzing the Performance of an Internal Combustion Engine” issued to Hermann and U.S. Pat. No. 5,258,753 titled “Digital Engine Analyzer” issued to Jonker both teach engine analyzers in which spark pulse intervals are used to show how well an engine is performing. U.S. Pat. No. 3,972,230 titled “Detecting Malfunction in Cylinders of Internal Combustion Engines” issued to Hanson connects a tachometer to an engine and uses its output determine how well the engine is performing. While others teach useful diagnostic methods and devices, they do not utilize the same inputs, display the same outputs, or provide the engine functionality information the current invention provides.

### SUMMARY OF THE INVENTION

The invention provides information about the functionality of engines through an analysis and display of the output voltage of an electrical power generator that is driven by those engines. The output signal from engine-driven generators is analyzed based on its magnitude at different points in time.

In addition to an analysis and display that is based only on an engine generator's output signal, the invention also provides information about the functionality of specific engine components through an analysis of both that generator output signal and at least one other signal. In a preferred embodiment, that other signal is provided by an electrical sensor that detects the spark of a known cylinder so that specific points in time in the generator's output signal can be associated with the functionality of particular engine components. In another embodiment, a sensed fuel injector electrical pulse provides that other signal.

The invention uses standard electronic devices along with standard computers and computer peripheral devices that are understood by those who are familiar with the art. The invention's uniqueness arises from the manner in which the electronic devices are interconnected, which is shown in FIGS. 1 and 10, and from the formulas that are used to analyze the detected voltages, which are shown in FIG. 8.

### BRIEF DESCRIPTION OF THE DRAWINGS

FIG. 1: Block diagram of a preferred embodiment of the invention.

FIG. 2: Raw data before cylinder 5 fuel injector has been disconnected

FIG. 3: Averaged data before cylinder 5 fuel injector has been disconnected

FIG. 4: Averaged data after cylinder 5 fuel injector has been disconnected

FIG. 5: Multiple display of Voltage, Power, and Cylinder RPMs

FIG. 6: Multiple display of analysis of Voltage, Power, and Cylinder RPMs

FIG. 7 Live display of data and analysis

FIG. 8: Formulas used to calculate engine performance

FIG. 9: Warning displayed when analysis indicates a problem

FIG. 10 Schematic of invention

FIG. 11 Raw data from diesel engine before and after a fuel injector is disabled

### DETAILED DESCRIPTION OF THE INVENTION

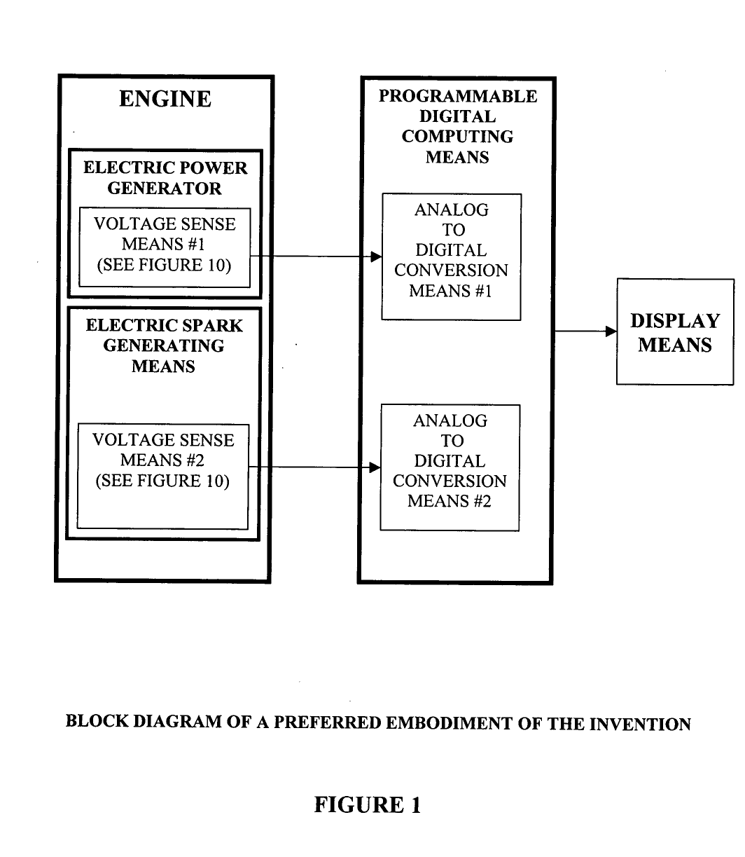

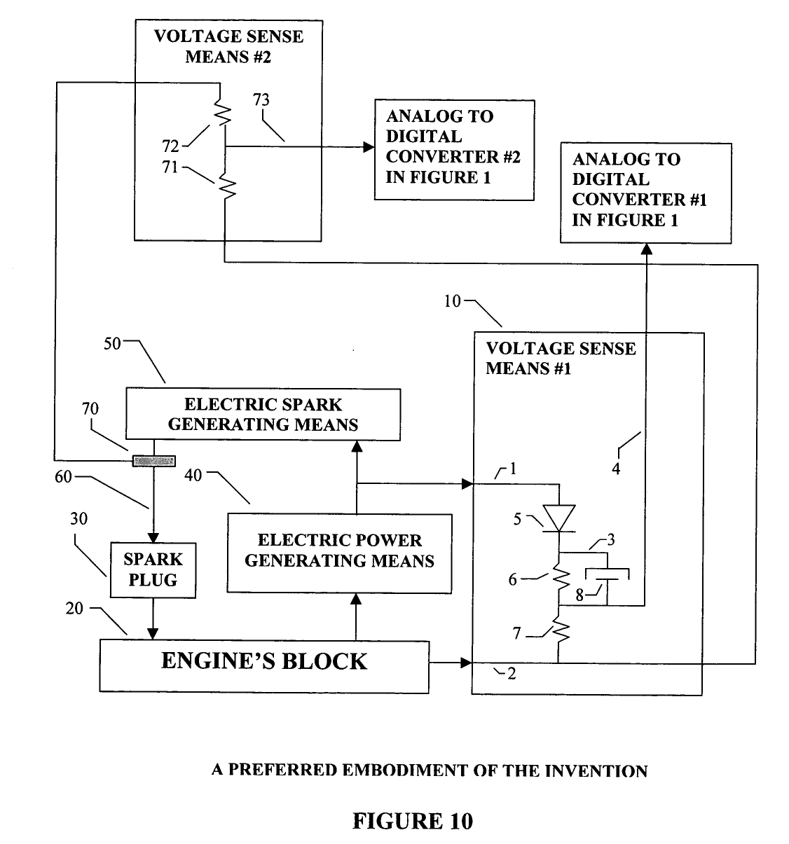

A preferred embodiment of the invention uses standard electrical components, a digital computer and software to detect and process signals from battery voltages. A block diagram of these devices is shown in FIG. 1. A schematic of these devices is shown in FIG. 10. The circuitry of a preferred embodiment is shown inside the box labeled 10, Voltage Sensor #1. It has diode 5, capacitor 6 and resistors 7 and 8. Diode 5, resistor 6 and resistor 7 are connected in series, while capacitor 8 is connected in parallel with resistor 6. Diode 5 is a standard signal diode, resistor 6 is a 10,000,000 ohm resistor, resistor 7 is a 200,000 ohm resistor, and capacitor 8 is a 5 micro-farad capacitor. Voltage sensor #1 connects first to Electric Power Generating Means 40 at node 1, and it connects second to ENGINE BLOCK 20 at node 2. Conductor 4 connects the output of Voltage Sensor #1 to Analog to Digital Converter #1 shown in FIG. 1. Voltage sensor #2 clamps around the spark plug wire with component 70. The voltage of this signal is reduced appropriately with resistors 71 and 72. Conductor 73 connects the output of Voltage Sensor #2 to Analog to Digital Converter #2 shown in FIG. 1.

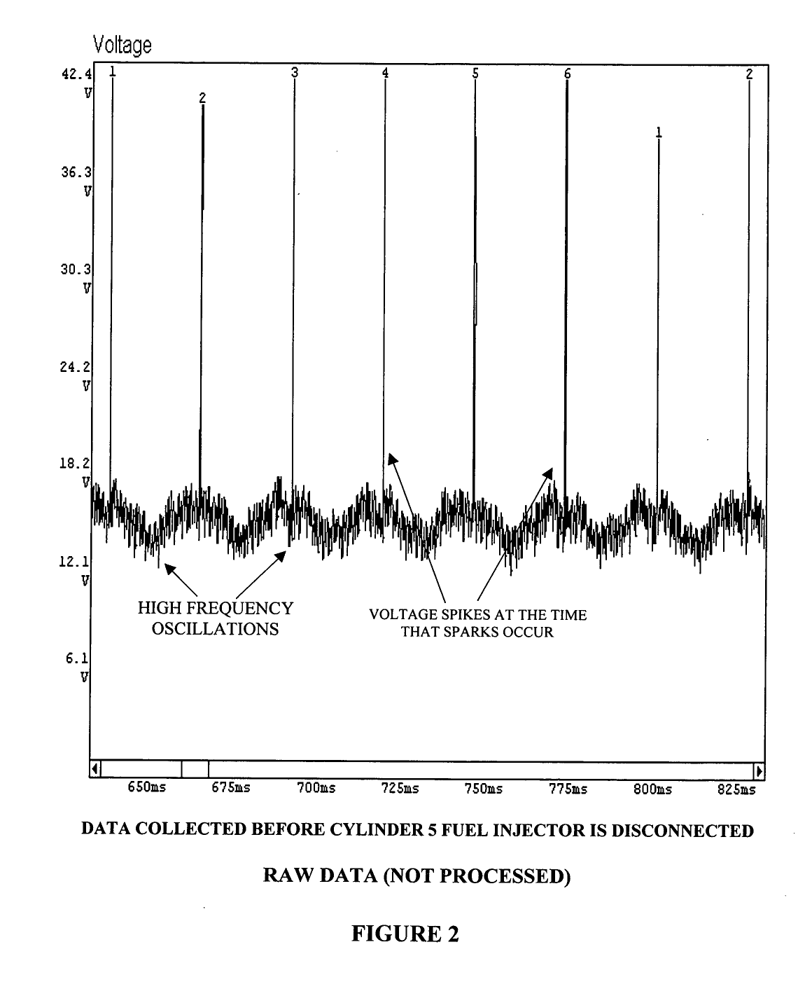

FIG. 2 shows the output of an engine's electric power generator that is mechanically coupled to the engine. This output has consistent positive voltage spikes that are sensed by the invention's hardware and analyzed by the invention's software. These spikes occur whenever a spark occurs in the engine, and one purpose of the analysis is to determine the precise time at which sparks occur.

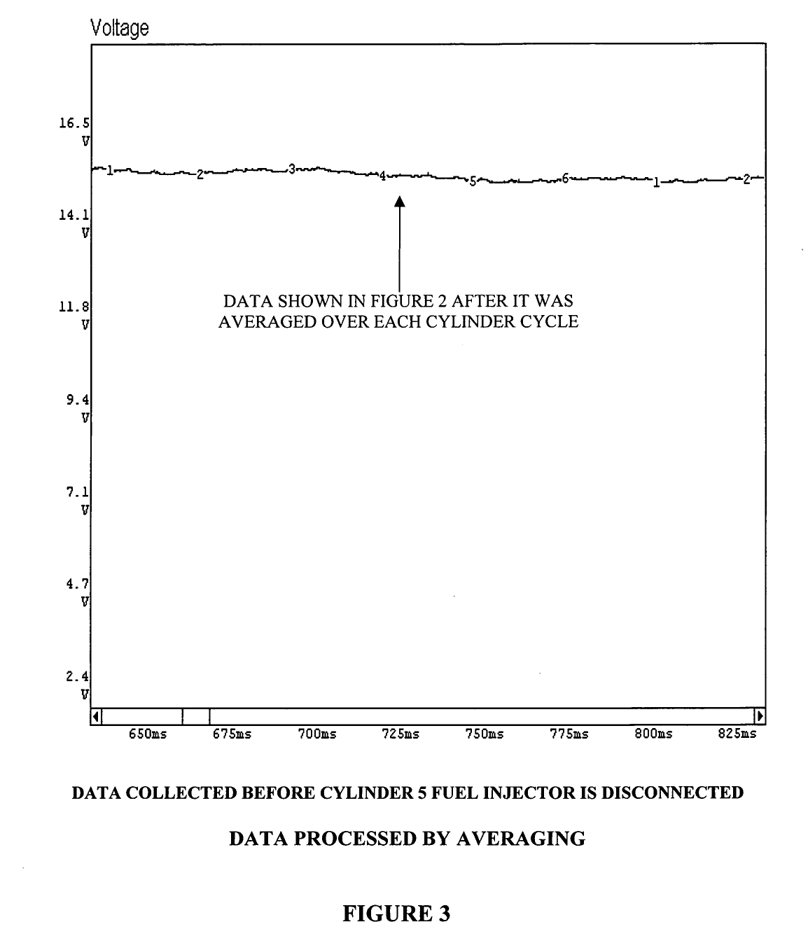

FIG. 3 shows the output of FIG. 2 averaged over the elapsed time from the firing of one cylinder to the firing of the next cylinder. The cylinder numbers that are written in the voltage waveform indicate the time when that cylinder's spark occurred.

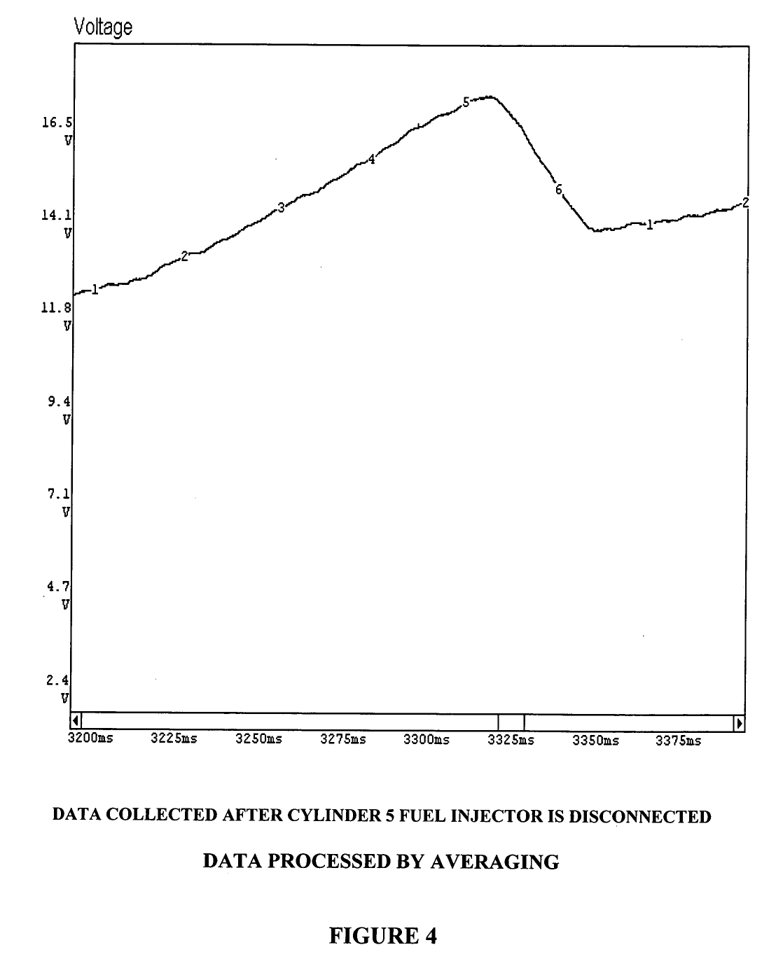

FIG. 4, like FIG. 3, shows the averaged output of the electric power generator, but after the fuel injector for cylinder 5 has been disconnected. That is why the very steady voltage reading of the electric power generator has now acquired a very large fluctuation. This newly fluctuating voltage peaks immediately after cylinder 5 generates a spark but does not generate power because it has no fuel to ignite. The voltage recovers after the other cylinders (starting with cylinder 6) have sparks that ignite fuel and produce power.

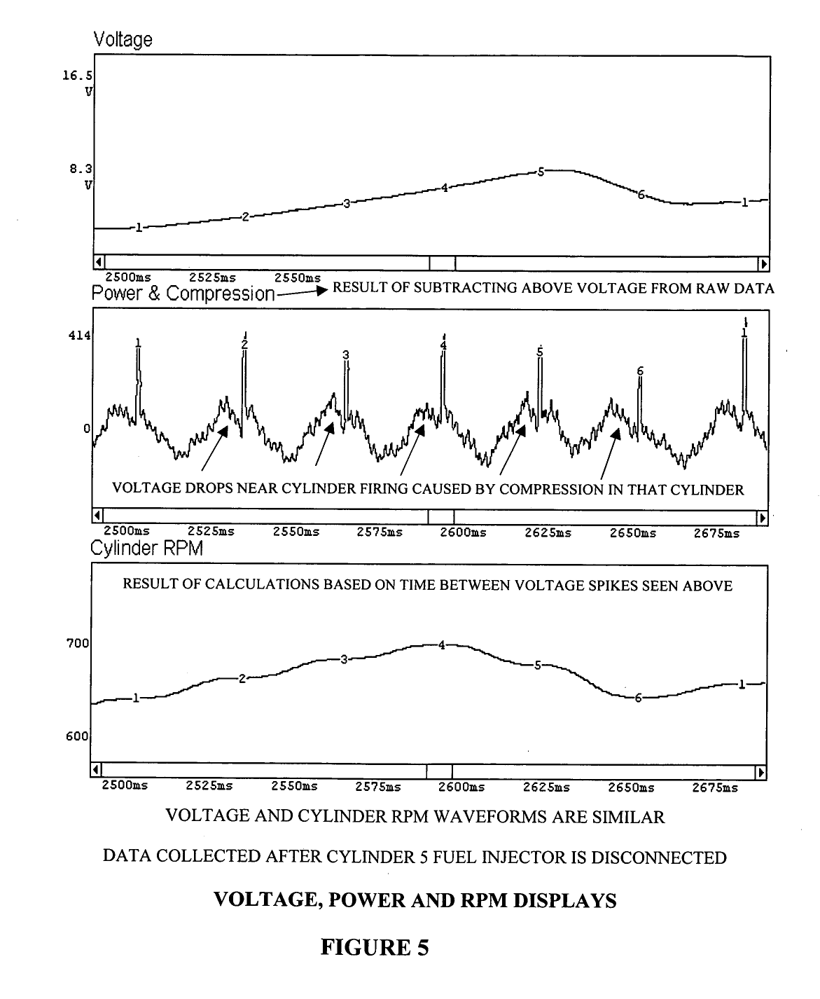

FIG. 5 is a complex multiple output that simultaneously shows three different displays. The top display is like FIG. 4 in that it is an averaged output of the electric generator after the fuel injector for cylinder 5 has been disconnected. The middle display is the result of subtracting the averaged voltage from raw data, a sample of which is shown in FIG. 2. The bottom display is the result of calculations based on the time between the voltage spikes that are visible in the middle display.

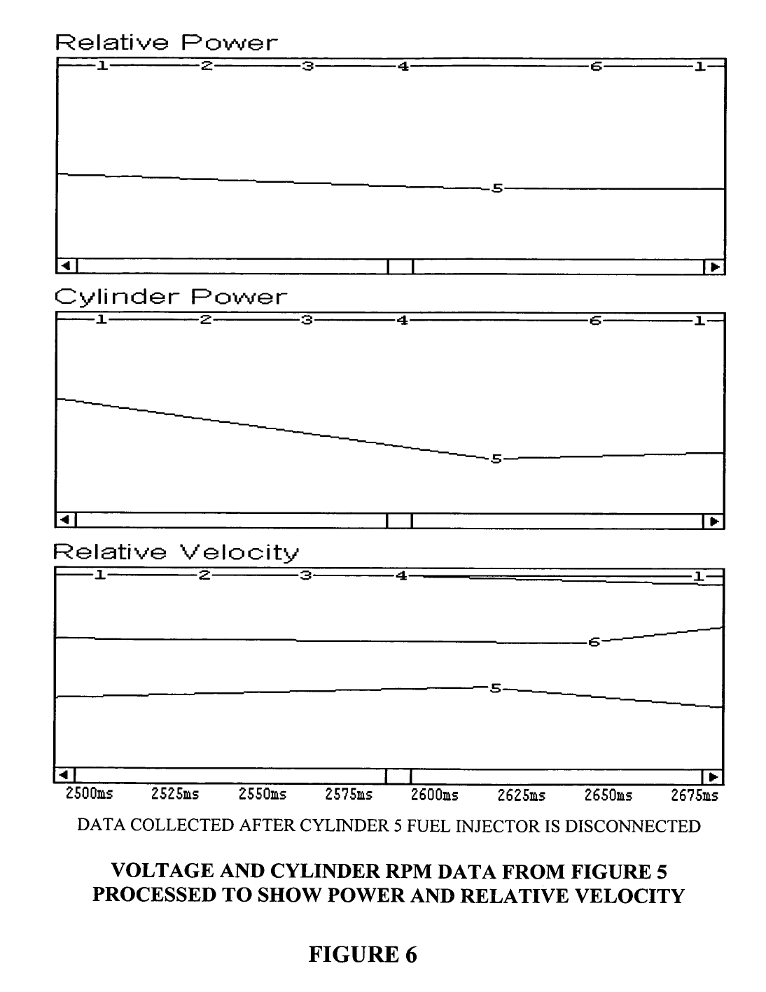

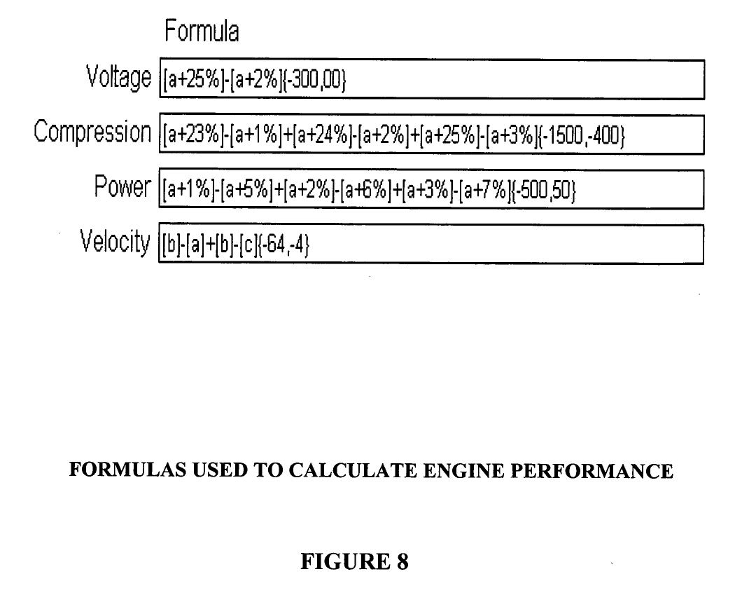

The three displays in FIG. 6 are derived through an application of formulas, which are shown in FIG. 8, to the outputs that are shown in FIG. 5. Each display in FIG. 6 is based on calculations related to the corresponding top, middle and bottom outputs shown in FIG. 5.

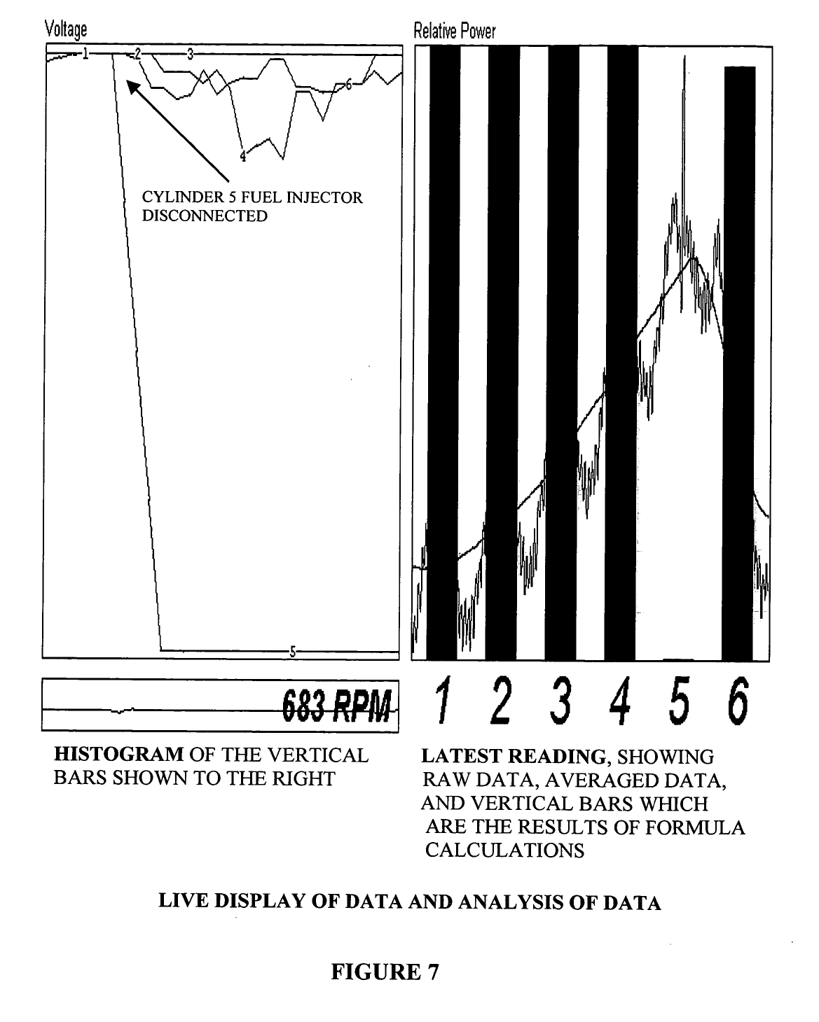

FIG. 7 is a captured image of a “live” display of an attached electrical generator's output voltage and an analysis of that voltage. The display has a left side and a right side. The right side shows latest engine cycle. In the background, raw and averaged data like that in the top display and middle display of FIG. 5 are shown. In the foreground, the results of an analysis of that data are depicted, with the computed values shown as vertical bars.

The left side of the display is the historical record (histogram) of the heights of the vertical bars that were calculated throughout the current “live” analysis of the output voltage. This display shows the calculated analysis as lines, similar to the displays in FIG. 6.

FIG. 8 shows the equations that are applied against the data to produce the lines and vertical bars that show the functionality of each cylinder. In these equations, “a” is the value (voltage or velocity) when the current cylinder's number is shown, and “b”, “c”, etc. select subsequent cylinders, while “z” and “y” select previous cylinders.

Points may also be selected by their percentage through the engine's cycle. For example, [a+27%] would be 27% of the time from the present cylinder's firing to its next firing. Another way of selecting points is by time. When that method is used, [b+12 ms] is 12 milliseconds after the next cylinder fires.

Values at those selected times are added by plus (+) signs and subtracted by minus (−) signs. Values at a given time may be either an actual value at that time or a value that has been averaged over a predetermined range of multiple readings before and after that time. The results of the calculations are expected to fall within a particular range for each engine. The lower limit for the range is generally set as the value for a failed cylinder, while the upper limit is set as the value for a normal cylinder. These limits are placed inside upper case brackets ({ }). An example of this is as follows: {−600,200}. When calculated valuations are displayed, they are clipped at the limiting values and centered inside those values. For example when using the above limits, −200 would appear in the middle of the display, 200 would appear at the top of the display, and 230 would also appear at the top of the display.

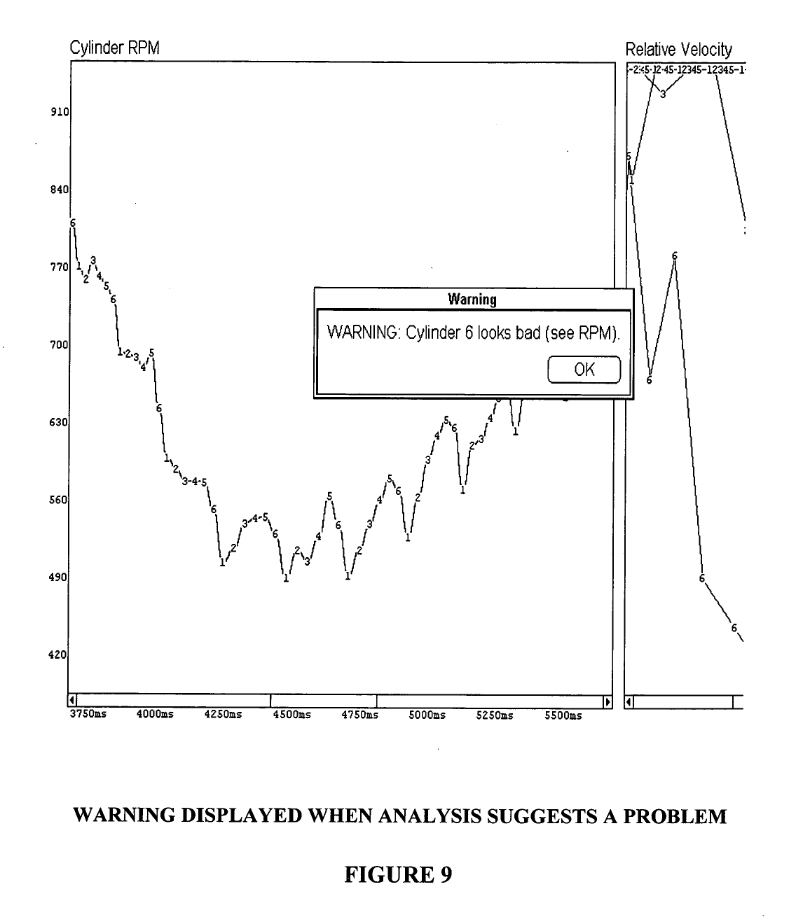

When the analysis determines that a particular cylinder has a possible problem, a warning is issued. An example of such a warning is shown in FIG. 9. This determination of a possible problem is based on one or more cylinders having calculated valuations that indicate they are not functioning properly.

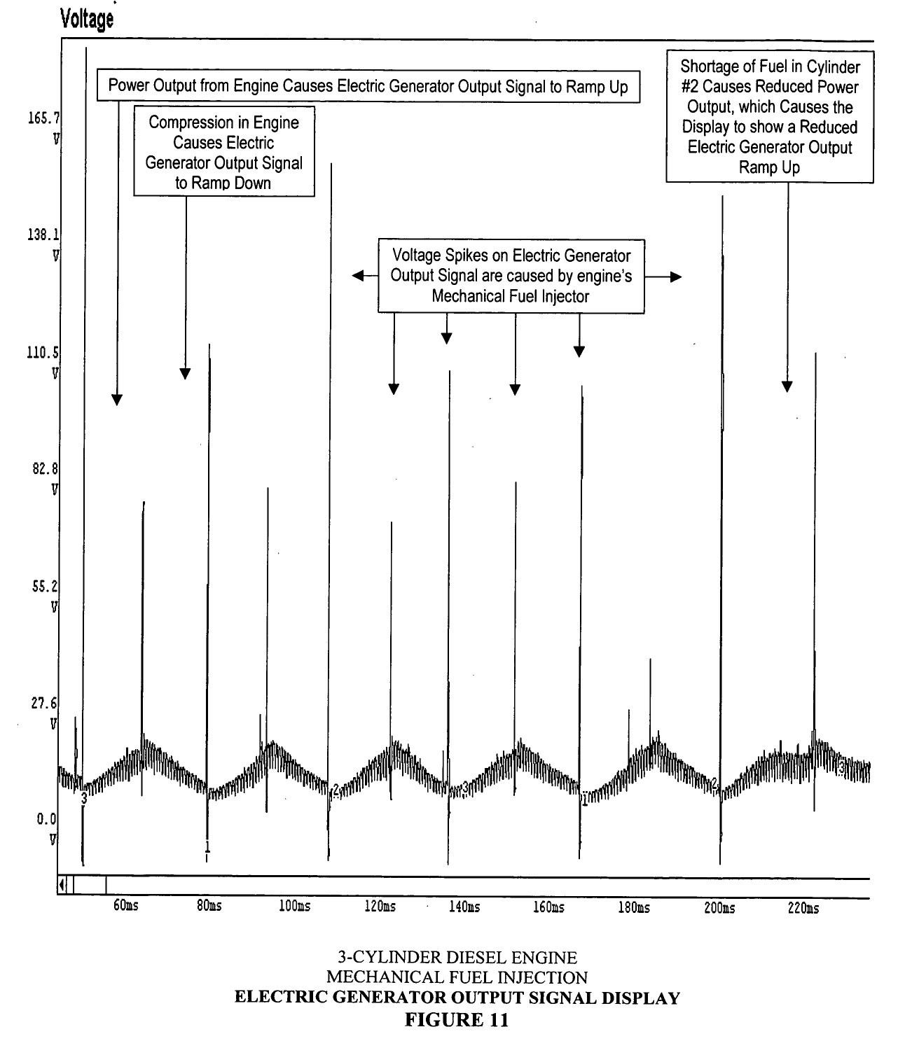

FIG. 11 shows a 3 cylinder diesel engine in which cylinder #2 is first normal, and then has its fuel injector partially disabled. The diesel engine's electric generator output signal is strikingly similar to the spark-ignited engine's output signal. Therefore, all the invention's features that have been herein disclosed for spark-ignited engines also apply to diesel engines.

I claim:

1. An apparatus that shows the functionality of an engine, where said engine drives an electric generator and wherein said apparatus displays an output signal from at least one driven electric generator, said output signal being detected and displayed in such a way as to impart useful engine functionality information.

2. The apparatus of claim 1 wherein the said output signal is analyzed so as to reveal points in time when specific known events regularly recur, either in the said engine or in components that are physically or electrically coupled to the said engine.

3. The apparatus of claim 1 wherein the said output signal is analyzed so as to reveal points in time when sparks regularly recur.

4. The apparatus of claim 1 wherein the said output signal is analyzed so as to reveal points in time when fuel injector operations regularly recur.

5. The apparatus of claim 1 wherein at least one mathematical formula is applied to the said output signal so as to reveal the functionality of the engine.

6. The apparatus of claim 1, wherein the said output signal is synchronized with at least one other signal, and where said other signal occurs at a recognized point in the operation of said engine.

7. The apparatus of claim 6, wherein at least one mathematical formula is applied to the said synchronized signals so as to compute at least one result that divulges information about the engine's functionality.

8. A method for showing the functionality of an engine, where said engine drives at least one electric generator and wherein said method displays an output signal from at least one of said engine's driven electric generators in such a way as to impart useful engine functionality information.

9. The method of claim 8, with the added step of analyzing the said output signal so as to reveal points in time when specific known events regularly recur, either in the said engine or in components that are physically or electrically coupled to the said engine.

10. The method of claim 8, with the added step of applying at least one mathematical formula to the said output signal so as to reveal the functionality of said engine.

11. The method of claim 8, with the added step of synchronizing the said output signal with at least one other signal, and where said other signal occurs at a recognized point in the operation of said engine.

12. The method of claim 8, with the added steps of synchronizing the said output signal with at least one other signal and applying at least one mathematical formula to the synchronized signals so as to compute and display at least one result that imparts useful information about the engine's functionality.
